(19) United States
(12) Patent Application Publication
(10) Pub. No.: US 2015/0077208 A1
(43) Pub. Date: Mar. 19, 2015

(54) HIGH-Q PARALLEL-TRACE PLANAR SPIRAL COIL FOR BIOMEDICAL IMPLANTS

(71) Applicants: Ken Goldman, Olmsted Falls, OH (US); Hao Jiang, San Francisco, CA (US); Shuvo Roy, San Francisco, CA (US)

(72) Inventors: Ken Goldman, Olmsted Falls, OH (US); Hao Jiang, San Francisco, CA (US); Shuvo Roy, San Francisco, CA (US)

(21) Appl. No.: 14/027,732

(22) Filed: Sep. 16, 2013

(51) Int. Cl. H01F 27/28; H02J 7/02; H01F 38/14; H04B 5/00

(52) U.S. Cl. CPC H01F 27/2804; H04B 5/0037; H02J 7/025; H01F 38/14
USPC 336/200

(57) ABSTRACT

A parallel-trace spiral coil comprising a plurality of electrically-isolated, parallel connected metal traces with high Q factor for use in bio-medical implants.

This application claims the benefit of U.S. Provisional Application No. 61/701,334, filed Sep. 14, 2012.

This invention was made by an agency of the United States Government or under a contract with an agency of the United States Government. The name of the U.S. Government agency: National Institutes of Health, National Institute of Neurological Disorders and Stroke, Phase II and the Government contract number:5R44NS052939-03. A collaborated research project in the Pediatric Device Consortium/UCSF (University of California San Francisco)/SFSU (San Francisco State University)

### FIELD OF THE INVENTION

Embodiments of the present invention relate to Planar Spiral Coil (PSC) which is an essential component in bio-medical implants (from hereon may be referred to as implants). In particular, the invention relates to the quality factor (Q) of PSCs, which is critical to the performance of an implant.

### BACKGROUND OF THE INVENTION

The use of implantable devices to remedy medical conditions is becoming increasingly frequent as the size and cost of such devices shrink. Many people with medical conditions who, in the past, were burdened with the prospect of remaining close to an analytical or treatment device have newfound freedom with implantable devices that allow them to receive the analysis and/or treatment they need from the implantable devices.

The Planar Spiral Coil (PSC) is an essential component in implants and is responsible for efficient wireless charging of the implant and effective wireless sensing and transmitting of useful diagnostic information. However, in the implants, a long metal trace forms a large-size PSC with a large cross-section area and a low quality factor (Q).

### SUMMARY OF THE INVENTION

This Summary is provided to comply with 37 C.F.R. §1.73, requiring a summary of the present technology briefly indicating the nature and substance of the present technology. It is submitted with the understanding that it will not be used to interpret or limit the scope or meaning of the claims.

It is an object of embodiment of the present invention to achieve the Q enhancement of the PSC of the implant by reducing the resistance per unit length of the inductor in the LC resonator. This enhancement is provided by creating a parallel-trace design, which consists of splitting the single metal trace into a plurality of electrically-isolated, parallel-connected traces with the same total cross-section area. The parallel-trace PSCs have lower parasitic resistance than the single-trace with the same design. Therefore the parallel-trace PSCs provide an LC resonator which has a higher Q than that with the single-trace PSC.

### BRIEF DESCRIPTION OF THE DRAWINGS

While the appended claims set forth the features of the present invention with particularity, the invention, together with its objects and advantages, will be more readily appreciated from the following detailed description, taken in conjunction with the accompanying drawings, wherein:

FIG. 1A-1B illustrates implantable MEMS pressure sensor and Wireless power transfer with a handheld device;

FIG. 2A-2B illustrates the cross-section of single-trace PSC and parallel-trace PSC

FIG. 2C illustrates Circular single-trace and parallel-trace PSC with different turns

FIG. 2D illustrates Rectangular single-trace and parallel-trace PSC with the same number of turns

FIG. 2E illustrates Circular parallel-trace PSC with different turns

FIG. 2F illustrates the unit-length resistance for single-trace and parallel-trace PSC;

FIG. 3 illustrates the cross section of a single-trace PSC;

FIG. 4 illustrates the cross section of a parallel-trace PSC with the top-layer exposed to open air;

FIG. 5 illustrates the cross-section of parallel trace PSC with all the layers of the metal trace embedded in a substrate;

FIG. 6 illustrates the parallel traces PSC without any modifications;

FIG. 7 illustrates the parallel trace PSC with metal stubs at the corner and circular vias;

FIG. 8 illustrates parallel-trace PSC with square metal stubs at the corner;

FIGS. 9A and 9B illustrates the magnetic flux density whose direction is parallel to the electrical current direction for a parallel-trace PSC;

FIGS. 10A and 10B illustrates the magnetic flux density whose direction is parallel to the electrical current direction for a single-trace PSC;

FIG. 11 illustrates the magnitude of impedance versus frequency for a 5-turn parallel-trace PSC;

FIG. 12 illustrates the phase of impedance versus frequency for a 5-turn parallel-trace; and

FIG. 13 illustrates the top view of a 3-turn multi-trace PSC with modified corners as per the current invention.

### DETAILED DESCRIPTION OF THE INVENTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only to avoid obscuring the invention.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

While the appended claims set forth the features of the present invention with particularity, the invention, together with its objects and advantages, will be more readily appreciated from the following detailed description, taken in conjunction with the accompanying drawings, wherein:

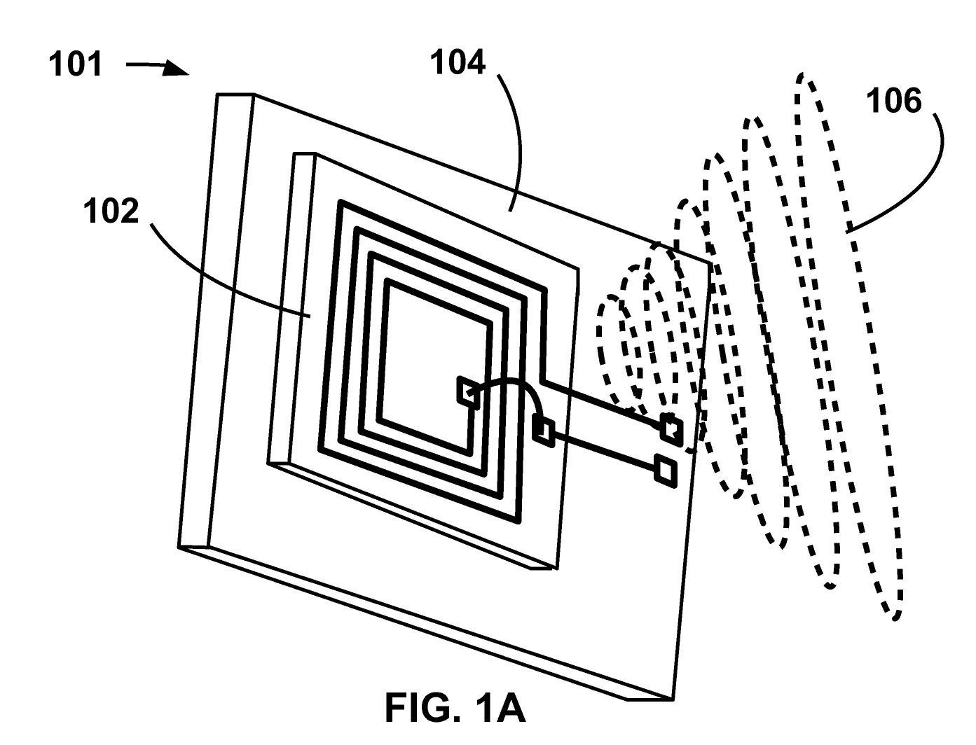

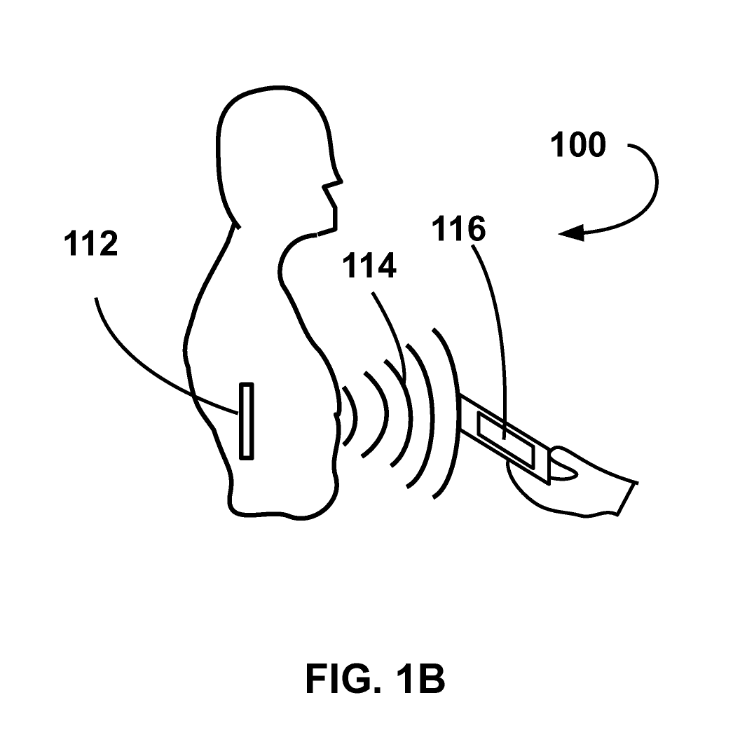

FIG. 1A illustrates a multi-turn square spiral inductor or antenna for powering or telemetry (102) placed on a biological specimen (104), for example, bone or muscle. 106 indicates the Radio Frequency (RF) radiation. FIG. 1B illustrates a portable, palm-sized, hand-held device for wireless powering, interrogation and data retrieval from at least one biosensor (112) embedded in a human body for medical diagnosis. The miniaturized spiral inductor/antenna circuit for powering and telemetry is integrated with a bio-micro-electro-mechanical-systems (bio-MEMS) pressure sensor (112). 114 represents the signals from the bio-MEMS and 116 represent the palm-sized, hand-held device.

Biomedical implants are expected to play an increasing role in medicine. Planar Spiral Coil (PSC) or inductor is an essential component (passive wireless sensor with no onboard power source) in bio-medical implants for efficient wireless charging and effective wireless sensing. An external source may be used to charge the device and get useful data from the device wirelessly. The quality factor or Q factor represents the effect of electrical resistance, and thus energy dissipation, of the electrical circuit. The quality factor (Q) of PSCs is critical to the implant's performance. In wireless charging, delivered power and efficiency is directly proportional to the Q of the LC resonator formed by the PSC. In wireless sensing, higher Q of the LC resonator based wireless sensor leads to longer operating distance (how far inside the body an implantable sensor can be placed).

Higher Q leads to higher induced current in the inductor at the operating frequency. The higher current leads to a stronger magnetic field and thus, provides a longer operating distance of the wireless sensor. The PSC is an ideal device to realize the inductive coupling in a passive wireless sensor for biomedical applications. The preferred embodiment of the invention achieves higher quality factor (Q) of the PSC or inductor.

Parasitic resistance of a conductor may have a big impact on the Quality factor (Q) of a planar spiral coil (PSC). Parasitic resistance of PSC is proportional to its length and unit-length resistance Rₗ. The parasitic resistance may be decreased by reducing the length of the PSC. However, reducing the length of the PSC also reduces the overall strength of magnetic field created by the PSC. Reducing the length (l) of a PSC may have a negative impact on Q, while increasing the length of PSC may often capture sufficient magnetic field, which in turn may be beneficial in reducing the unit-length resistance of the metal trace, Rₗ, and thus may become the primary approach to improve the Q of PSC.

A single long metal trace planar spiral coil in bio-medical implants will form a large size PSC with large cross section area. It is necessary to have the long length for a single metal trace PSC so that the electromagnetic field is strong. However, long metal trace also brings in concerns about resistance per unit length. Ideally if the resistance per unit length is small, the Q factor will be higher. The unit-length resistance of the metal trace, Rₗ, may be reduced by reducing the parasitic resistance of a PSC. To effectively reduce the parasitic resistance of a PSC, a single trace PSC may be split into a plurality of parallel layers which may help in reducing the parasitic resistance of a PSC. This may be referred to as parallel-trace design, which may be used instead of a single trace PSC with excessive width (w) and thickness (t).

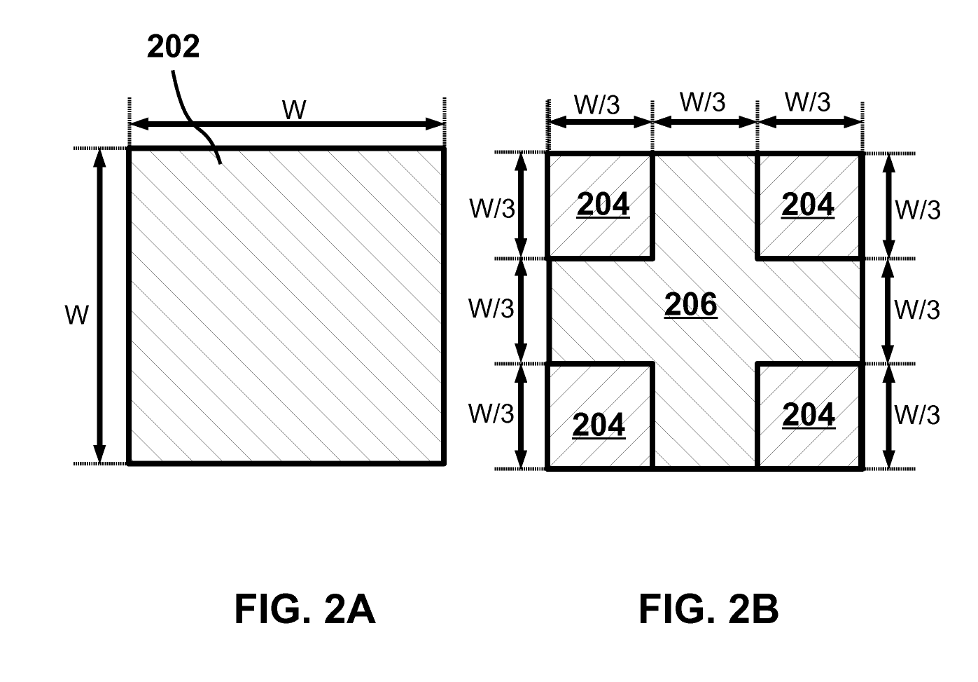

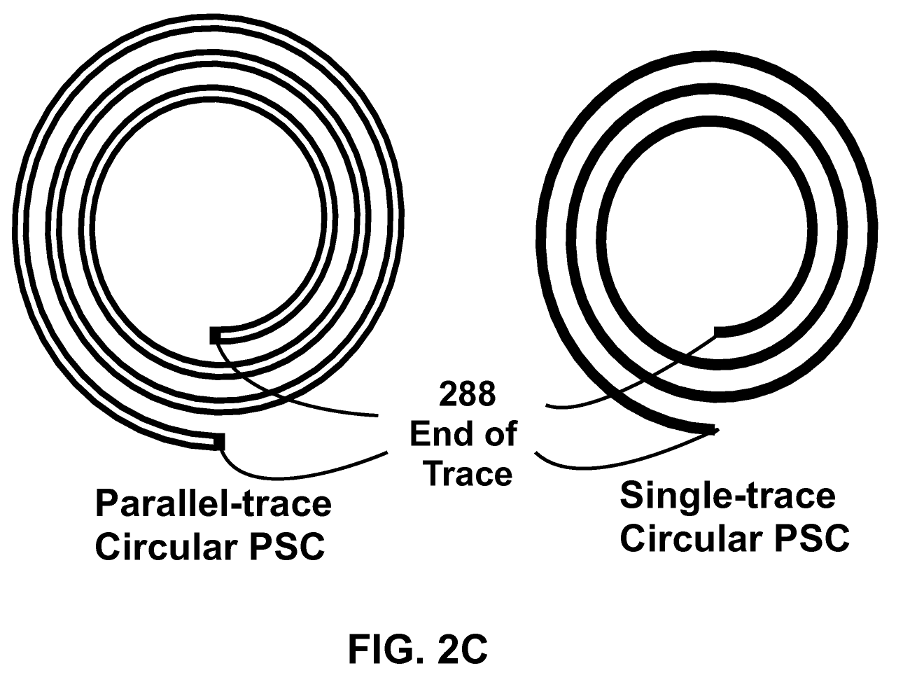

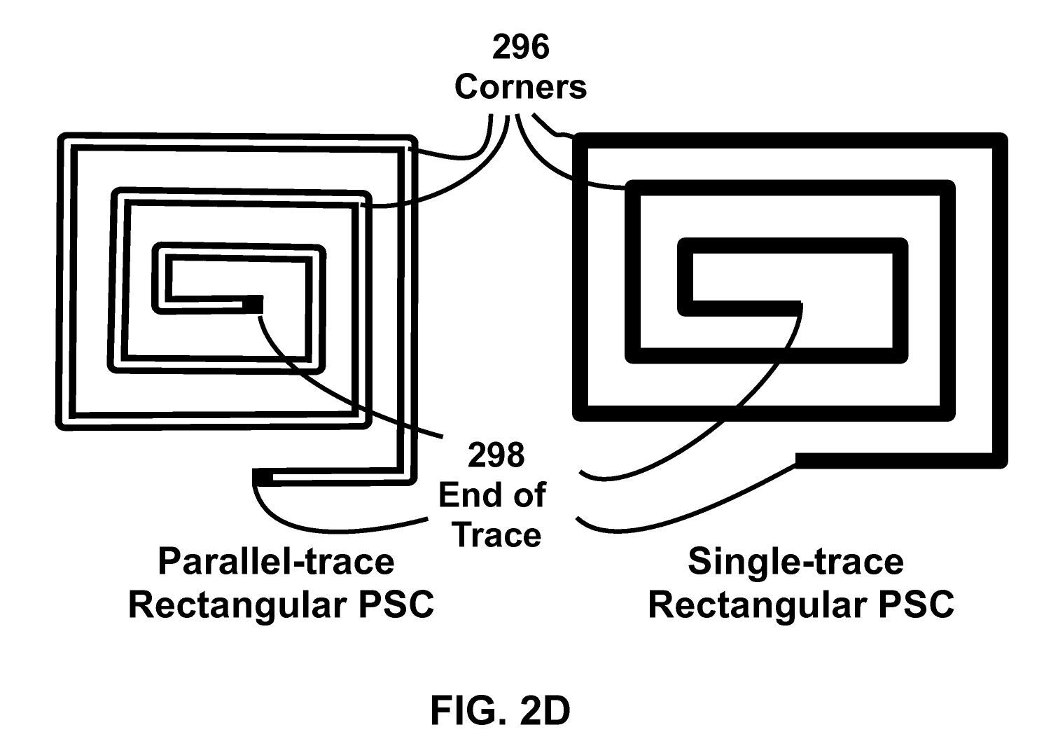

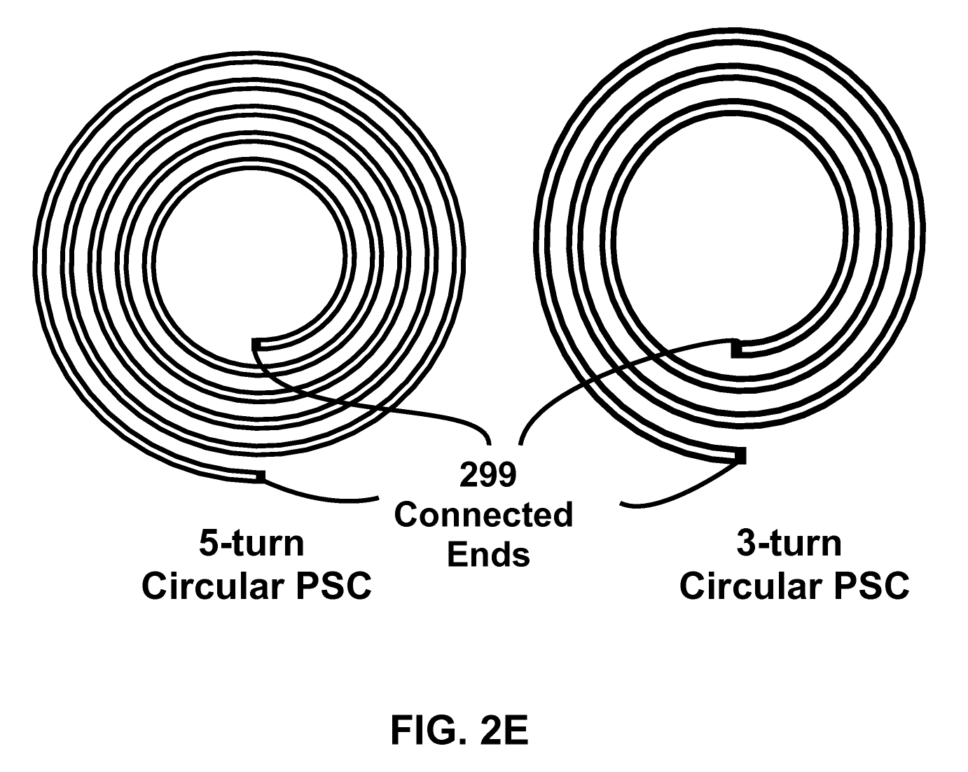

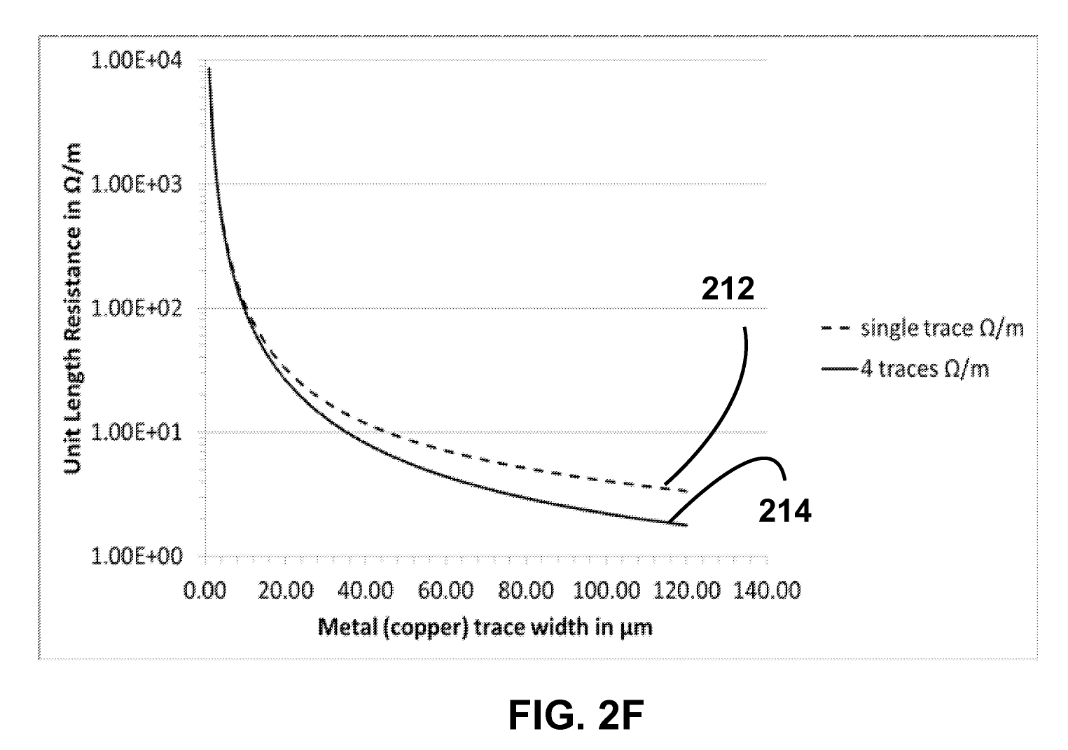

Parallel-trace concept is illustrated in FIG. 2A and FIG. 2B. FIG. 2A depicts the cross section of a single trace PSC whose width is w and thickness is t, which is equal to the width w. FIG. 2B depicts the cross section of a parallel-trace PSC. Instead of a single trace with width w, a parallel-trace with four conductors of width ⅓^{rd} the width of single trace is arranged as shown in FIG. 2B. In FIG. 2B, 204 represents the parallel-trace and 206 represents the substrate which holds the parallel traces together. The total width w in FIG. 2A and FIG. 2B is equal. FIG. 2B represents one of the ways in which a parallel-trace may be formed. With the parallel-trace, the electric current flows through all four traces, which may have a beneficial effect, as explained later.

FIG. 2C shows the top-view of a circular single-trace and parallel-trace PSC. Coils can be of various shapes. For example, circular (as shown in FIG. 2C), rectangular (as shown in FIG. 2D), oval, star, etc. A parallel trace may also be formed by splitting the single trace and placing the traces side-by-side as depicted in FIG. 2C. As has been explained earlier, the parallel-traces may also be formed by stacking the metal traces or both (stacked+side-by-side).

FIG. 2E provides the top view of a parallel-trace PSC. FIG. 2E shows the concept of turns of a parallel-trace PSC. Specifically, a 3-turn and a 5-turn parallel-trace PSC are shown in the figure. The electrical properties of the parallel-trace PSC with different turns differ in different operating conditions. The number of turns provides one dimension in the design of a PSC. Depending on the operating requirements different turn PSCs may be used. As shown in FIG. 2E, the ends of the parallel trace may be connected together as shown by 299 whether the traces are placed side-by-side and/or stacked. As shown in the rectangular traces of FIG. 2D, the rectangular single/parallel traces have corners which may need to be designed and connected appropriately as explained in later paragraphs.

The unit-length resistance Rₗ alluded to in the earlier section is further dependent on the skin effect.

Skin effect is the tendency of an alternating electric current (AC) to become distributed within a conductor such that the current density is largest near the surface of the conductor, and decreases with greater depths in the conductor. The electric current flows mainly at the “skin” of the conductor, between the outer surface and a level called the skin depth (δₛₖᵢₙ). The skin effect causes the effective resistance of the conductor to increase at higher frequencies wherein the skin depth is smaller, thus reducing the effective cross-section of the conductor.

Further, the conductive nature of bio-tissues may cause absorption of heat, light, electrical energy, electromagnetic radiations, etc. To minimize the absorption caused by the conductive bio-tissues, the operating frequency of the passive wireless sensor usually is in the range of 10 MHz to 50 MHz. The corresponding skin depth of the copper trace, δₛₖᵢₙ, is in the range of 20 μm to 9 μm.

The metal traces used in biomedical applications, are much wider and thicker than those in the standard IC (Integrated Circuit) technologies. At RF (Radio Frequency), the reduction in unit-length resistance, Rₗ, slows down when the width (w) and thickness (t) are larger than 2 times δₛₖᵢₙ. As shown in FIG. 2F, 212 represents the unit-length resistance Rₗ vs metal trace width for a single-trace PSC and 214 represents the unit-length resistance Rₗ vs metal trace width for a parallel-trace PSC (splitting the single trace into four parallel connected traces with the same overall w and t under the assumption that the width is equal to the thickness (w=t)). Rₗ may be represented by the following formula.

$${R}_{1} = \frac{ρ}{wt} \times \frac{t}{δ skin ( 1 - exp ( - \frac{1}{δ skin} ) )} \times \frac{1}{1 + \frac{1}{w}}$$

Where ρ is metal trace's resistivity; δₛₖᵢₙ is skin depth; w is overall width; t is thickness of metal trace. Copper is the metal of choice because of its low resistivity (ρ_{cu}=1.7×10⁻⁸ Ωm). With the increase of the total w and t, the unit-length resistance of a copper trace at 10 MHz is calculated for the single-trace design and parallel trace design using the equation above and shown in FIG. 2E by 212 and 214 respectively, assuming w=t. With the single-trace design, the reduction of Rₗ dramatically slows down after w and t exceed 2 δₛₖᵢₙ which is about 40 μm at 10 MHz. By using a parallel-trace design (splitting the single trace into four parallel connected traces with the same overall w and t), the significant reduction of Rₗ still may effectively reduce the PSC's parasitic resistance by having large cross section area, without the limitation of the skin effect as shown by 214 in FIG. 2F.

The single metal trace has a width and thickness that is significantly larger than the skin depth δₛₖᵢₙ, whereas a plurality of electrically-isolated, parallel-connected traces have dimensions comparable to the two-times skin depth with the same total cross-section area. The parallel-trace PSCs used in human body implants operate at high frequencies and the skin depth at higher frequencies is smaller. The width and thickness of the parallel-trace PSC may have to be comparable to the skin depth for achieving significant reduction of Rₗ at high frequencies.

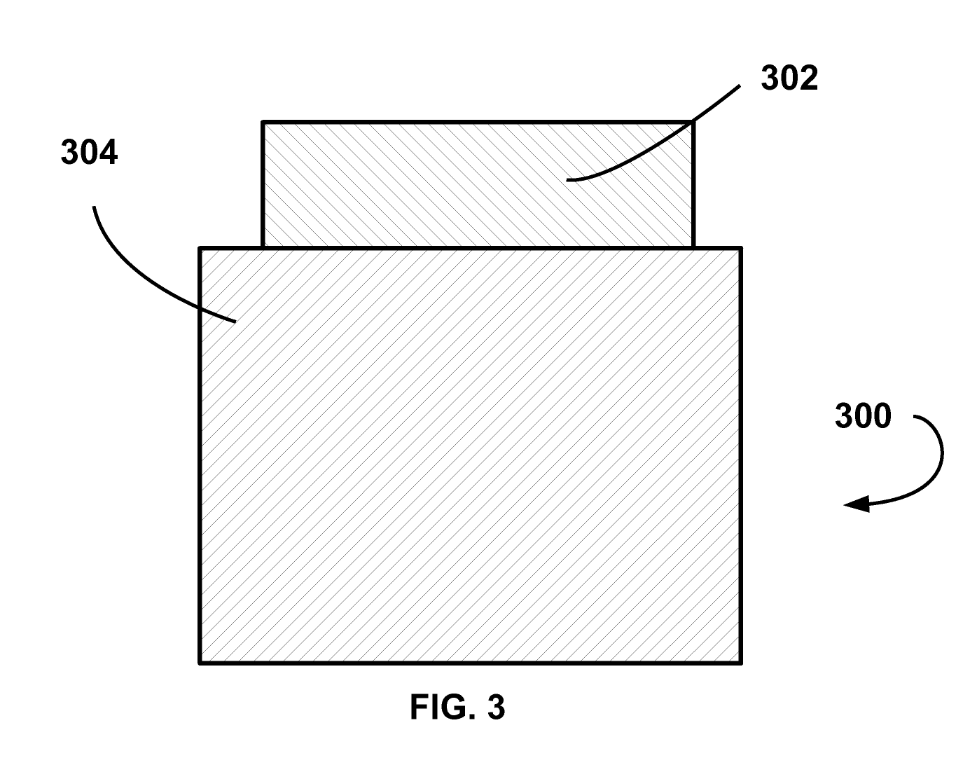

FIG. 3 illustrates a cross-section of a single-trace PSC design 300. The single-trace PSC design 300 includes a single metal trace 302 and a printed circuit board (PCB) substrate (304) (a board made from fiberglass or similar material). The width and thickness of single metal trace 302 is 765 μm and 114 μm respectively, but could be made smaller using different PCB fabrication techniques.

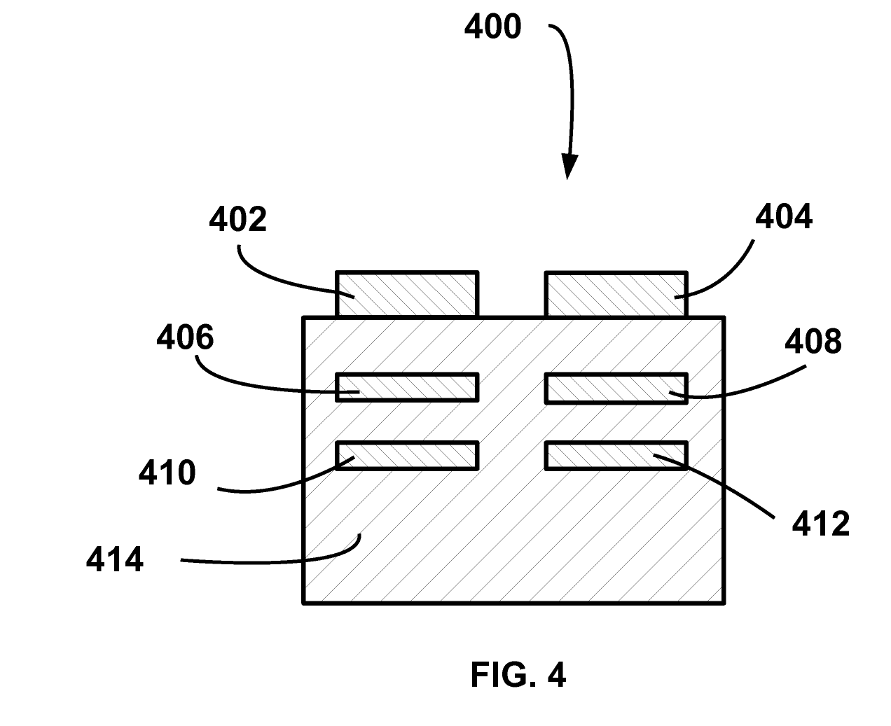

FIG. 4 illustrates a cross-section of a parallel-trace PSC design 400 in accordance with an embodiment of the present invention. The parallel-trace PSC design 400 may include six parallel-connected traces 402-412 located in three horizontal planes or layers, and the PCB substrate 414, for example a multi-layered PCB. As illustrated in FIGS. 4, 402 and 404 are the top-layer metal traces open to air, whereas 406, and 408, are the mid-layer metal traces and 410 and 412 are the bottom-layer metal traces, embedded in the PCB substrate 414.

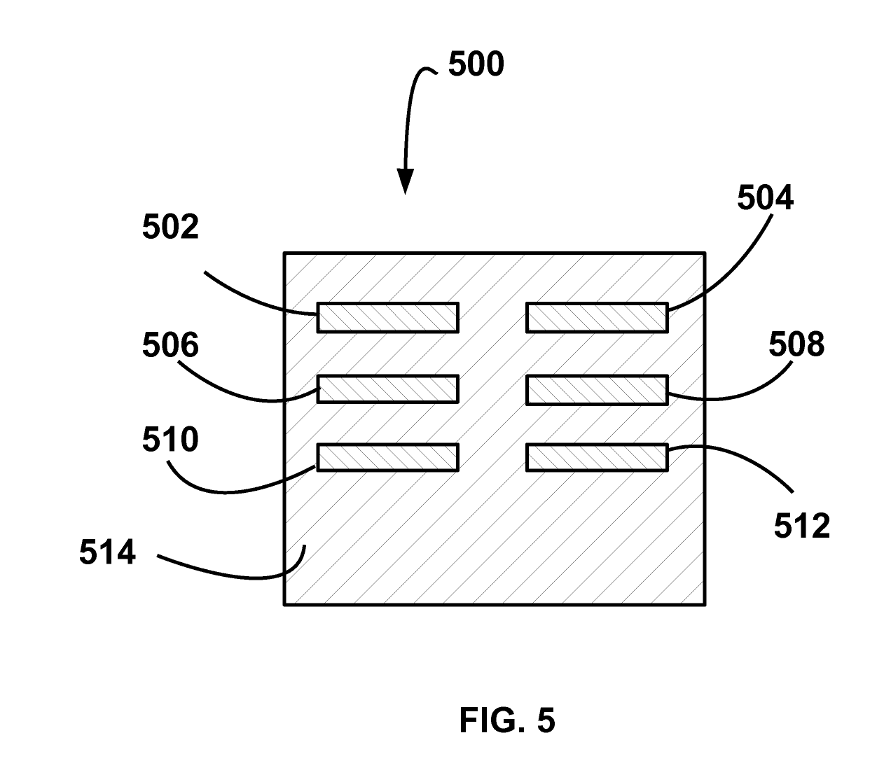

FIG. 5 illustrates a cross-section of a parallel-trace PSC design 500 in accordance with another embodiment of the present invention. The parallel-trace PSC design 500 includes top-layer (top horizontal plane) metal traces 502 and 504, middle-layer metal traces 506 and 508, and bottom-layer metal traces 510 and 512 embedded in the PCB substrate 514.

The sum of the thickness of each layer in parallel-trace PSC design 400, shown in FIG. 4, (for example, sum of thickness of 402, 406 and 410) is 115 μm and sum of thickness of each layer in parallel-trace PSC design 500 of FIG. 5 is 108 μm. The thickness values 115 μm and 108 μm are approximately similar to the thickness 114 μm of single-trace PSC 302. Further, the width of each parallel metal trace in parallel-trace PSC designs 400 (FIG. 4) and 500 (FIG. 5) is 255 μm, which is ⅓^{rd} of the total width of the single metal trace 302. However, total width of two parallel metal traces (for example, 406 and 408) is ⅔^{rd} of the total width of single trace 302 and a gap between the two parallel metal traces 406 and 408 is ⅓^{rd} of total width of single trace 302. Thus, the total width of the two parallel-connected traces (for example 406 and 408), including the space between them, is the same as that of a single-trace (765 μm) PSC 302. This achieves the objective that both the single-trace design 300 and the parallel-trace PSC designs 400 have approximately similar cross-section area and could be wound into a PSC of the same overall size.

The parallel-trace PSC design often assumes each trace to have the same electrical properties. However, the traces in different layers may have different dielectric materials surrounding them and the total length of the two side-by-side parallel-connected traces is different in a spiral design. For example, 400 (FIG. 4) may include traces disposed in different horizontal planes. Due to the different dielectric materials, the electrical properties may not be similar. This causes unbalance between the parallel-traces. There is a phase difference among parallel-traces due to the different dielectric environment. The top layer trace (402 & 404) is between air and substrate, the middle layer traces (406 & 408) that are buried in the substrate. Thus, the top layer trace has lower distributed capacitance among the top layer traces, while the middle layer trace has higher distributed capacitance among the middle layer traces. The capacitance difference will result in different wavelength at the same frequency. With the same physical length, there is phase difference between the top layer trace and the middle layer trace. In such a scenario, several designs, referred to as special designs, may be implemented to mitigate the unbalance between the parallel-connected traces. Another term that is commonly used is electrical length of a conductor. Even though the physical length is held constant, the electrical length of the conductor changes or varies based on the dielectric and the frequency of operation.

In one of the embodiments, the parallel metal traces may be embedded in the same dielectric material. As depicted in FIG. 5, the metal traces 502 and 504 in the top most horizontal plane, the metal traces 506 and 508 in the central plane and 510 and 512 in the bottom horizontal plane are all in the same dielectric material 514.

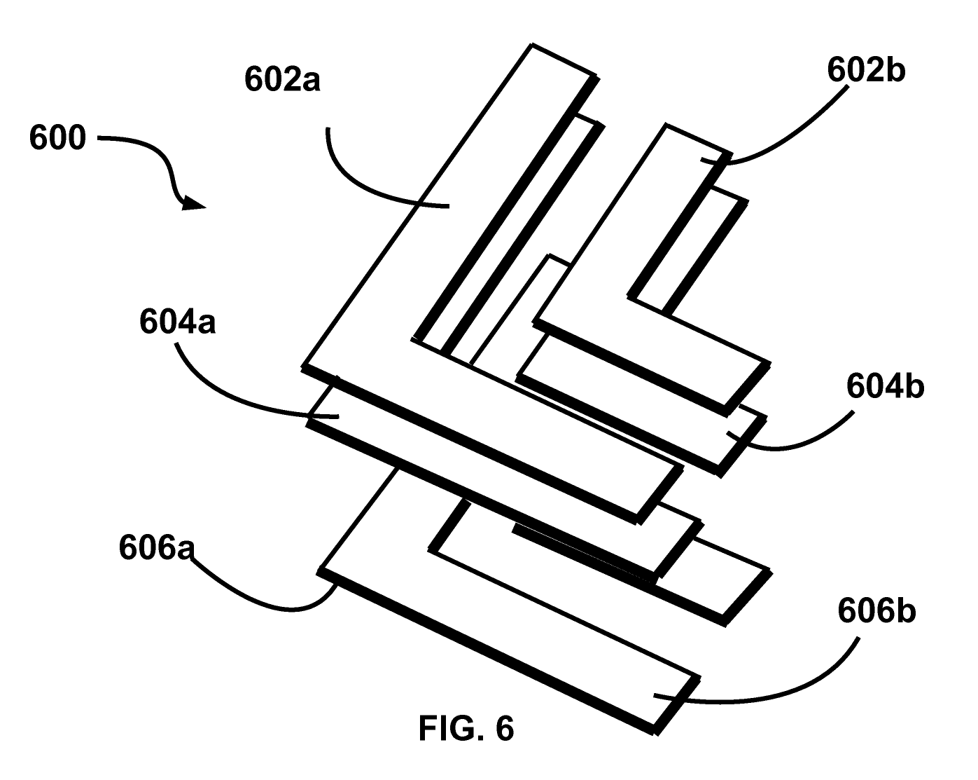

FIG. 6, illustrates the design in a three dimensional view. In this embodiment, the parallel-connected traces 602a-606b is formed without any special design to compensate for the unbalance. In this embodiment, the electrically-isolated traces may be embedded in the same dielectric material so that the electrical properties of the parallel-traces in different horizontal planes are similar. In this design, there is no special construction or design at the turning corners in different horizontal planes. 602a, 604a and 606a are parallel-connected traces in three different horizontal planes and 602b, 604b and 606b are corresponding side-by-side parallel-connected traces in three different horizontal planes without any special design.

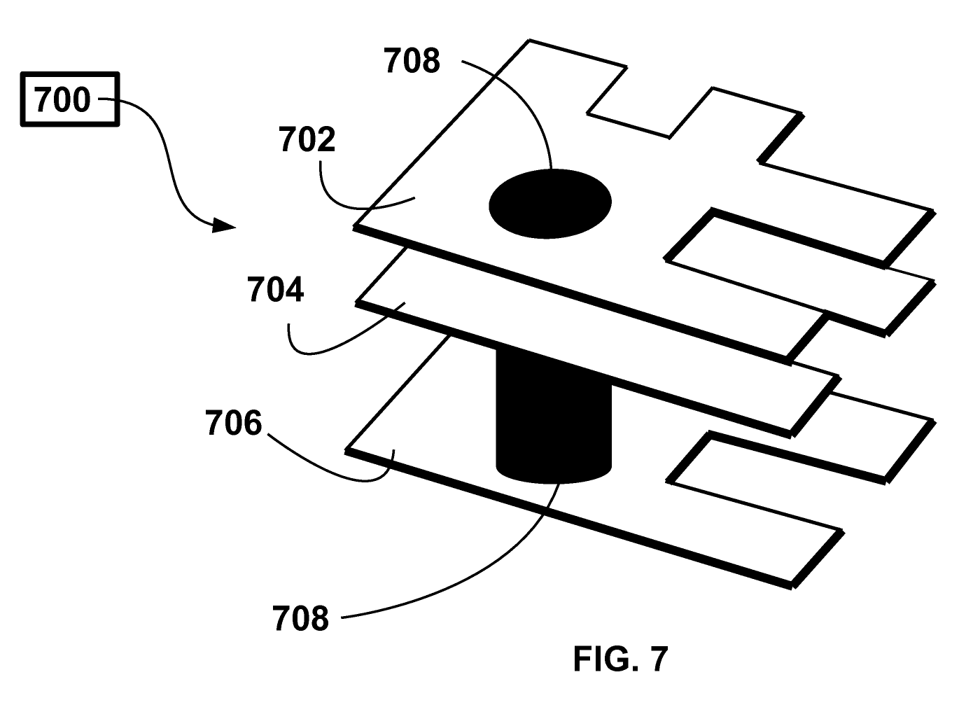

In another embodiment, wherein the corners are as shown in FIG. 7, 702, 704 and 706 are parallel-connected traces in three different horizontal planes connected to each other by the vertical vias 708. The vertical vias (708) are included at turning corners to minimize the said capacitance differences among the stacked parallel-connected traces 702, 704 and 706.

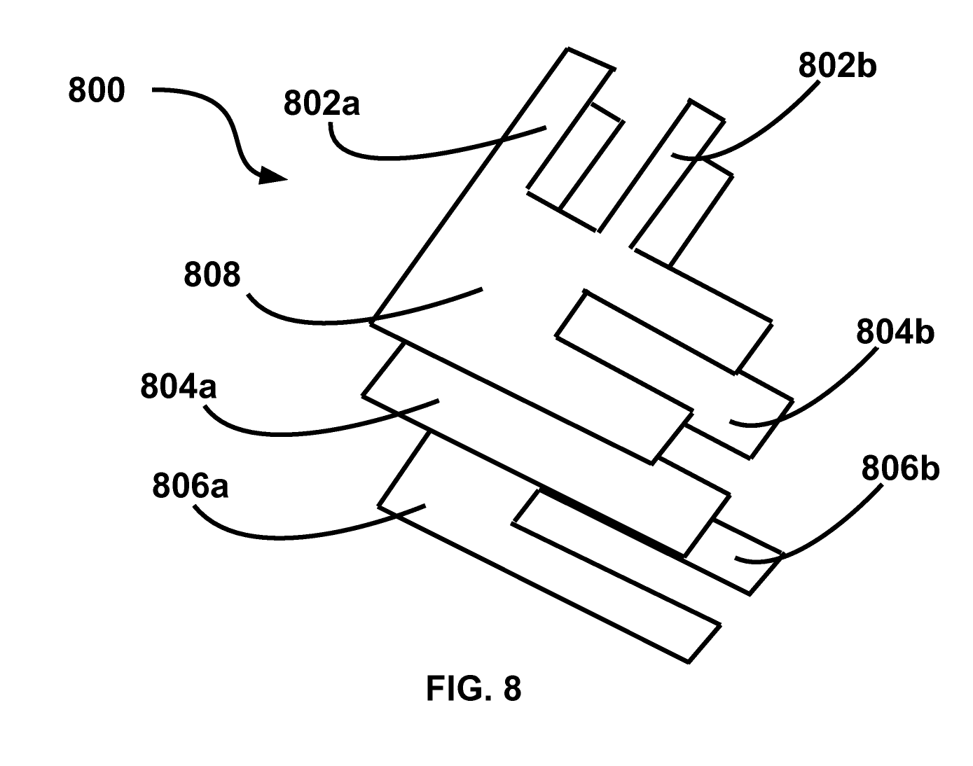

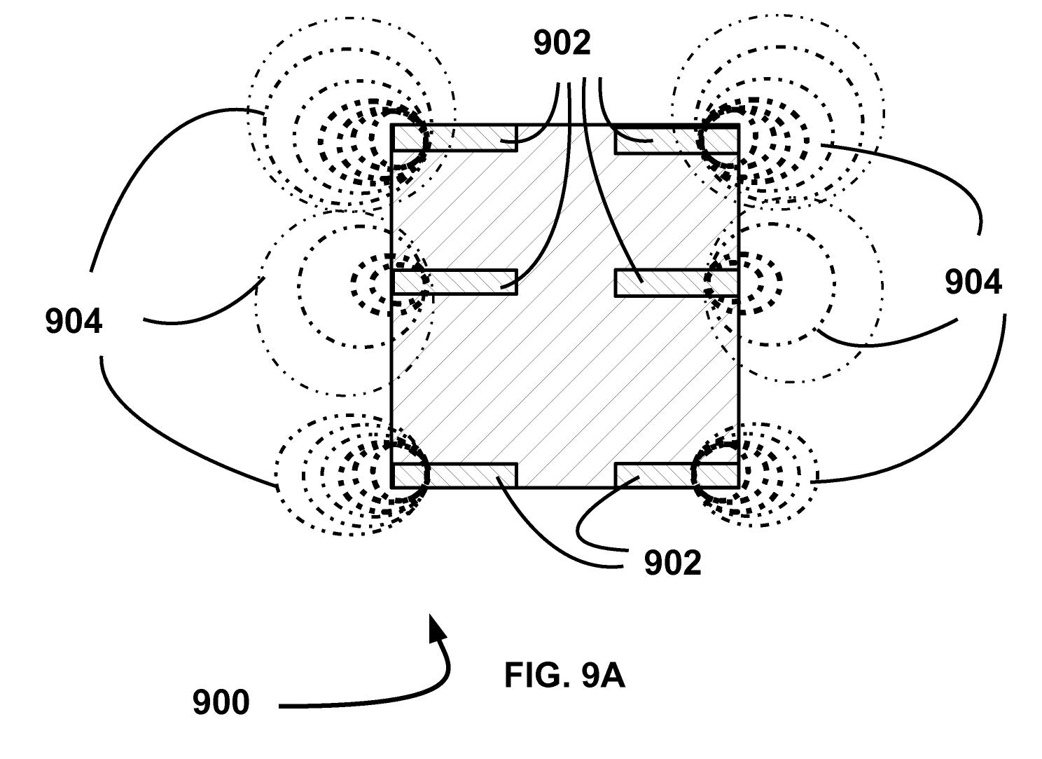

In another embodiment shown in FIG. 8, square-shape metal stubs (only metal stub 808 of upper or top-most horizontal plane shown) are placed at the turning corners to interconnect the turning corners of side-by-side parallel traces and minimize the length difference between the side-by-side parallel-connected traces. For example, the metal interconnecting stub 808 is placed between side-by-side parallel connected traces 802a and 802b. 802a, 804a and 806a are parallel-connected traces formed in three horizontal planes and 802b, 804b and 806b are corresponding side-by-side parallel-connected traces interconnected in the same way.

In another embodiment, the PSCs with the parallel-trace design may also be characterized with a planar ferrite layer beneath the substrate. Experimental results indicate that the mutual inductance between two face-to-face PSCs is increased by approximately 50% by including a ferrite layer to one of the PSCs. Therefore, having a ferrite layer can further enhance the PSC's coupling and extend the passive wireless sensor's operating distance. Since the ferrite layer does not require precise patterning, the technique may be easily adopted in the passive wireless sensor.

Square-shaped PSCs are made based on each embodiment depicted in various figures. FIGS. 6, 7 and 8 have the same outer dimension (2.5×2.5 cm) and the same inter-winding space (765 μm).

The descriptions of the present embodiments are not intended to limit the present invention but merely to provide an illustration of possible embodiments applying the principles of the invention. Numerous other uses could be made by those skilled in the art without departing from the spirit and scope of the invention.

The table below (TABLE 1) provides the characterization of the LC resonators formed by single-trace and parallel-trace PSCs. The embodiment with vertical vias 708 as depicted in FIG. 7 is used for the characterization experiment and is documented in TABLE 1. The experiments are conducted for PSCs having different number of turns. In the following table, f₀ represents the resonant frequency, Q is the Q factor, and P1-CV represents the design depicted in FIG. 7.

TABLE 1

| PSC | | f₀ | | Q | |
|---|---|---|---|---|---|
| Design | Capacitance | Single-trace | P1-CV | Single- | |
| Unit | in pF | in MHz | in | trace | P1-CV |
| 5-turn | 330 | 10.78 | 11.40 | 83 | 127 |
| 4-turn | 470 | 10.03 | 10.55 | 77 | 106 |
| 3-turn | 470 | 11.75 | 12.28 | 78 | 112 |

Q of the LC resonator may be derived from its resonant frequency fₒ and its −3 dB bandwidth Δf as Q=f₀/Δf. The resonant frequency fₒ is obtained based on the values of capacitance and inductance of the LC resonator. The Q of the parallel-trace design is improved by 38% to approximately 53% in comparison to that of the single-trace design as shown by the Table 1

The table below (TABLE 2) provides inductance at resonant frequency (11 MHz) for different turns of the single-trace PSC and the parallel-trace PSC for different embodiments. In TABLE 2, P1-CV represents the embodiment in FIG. 7, P1-no-CV represents embodiment in FIG. 6, P1-C represents embodiment in FIG. 8 with the top-layer of metal trace exposed to a different dielectric material (in this example open-air) and P2-C represents the embodiment in FIG. 8 with all the layers of metal traces embedded in the substrate.

TABLE 2

| | Single- | | | | |
|---|---|---|---|---|---|
| PSC | trace | P1-CV | P1-no-CV | P1-C | P2-C |
| unit | [nH] | [nH] | [nH] | [nH] | [nH] |
| 5-turn | 714 | 647 | 656 | 647 | 644 |
| 4-turn | 595 | 535 | 542 | 535 | 533 |
| 3-turn | 447 | 399 | 402 | 398 | 396 |

As shown in the table above (TABLE 2), the experimental results indicate that the inductance in the parallel-trace PSCs is consistently smaller than that of the single-trace PSCs with the same design.

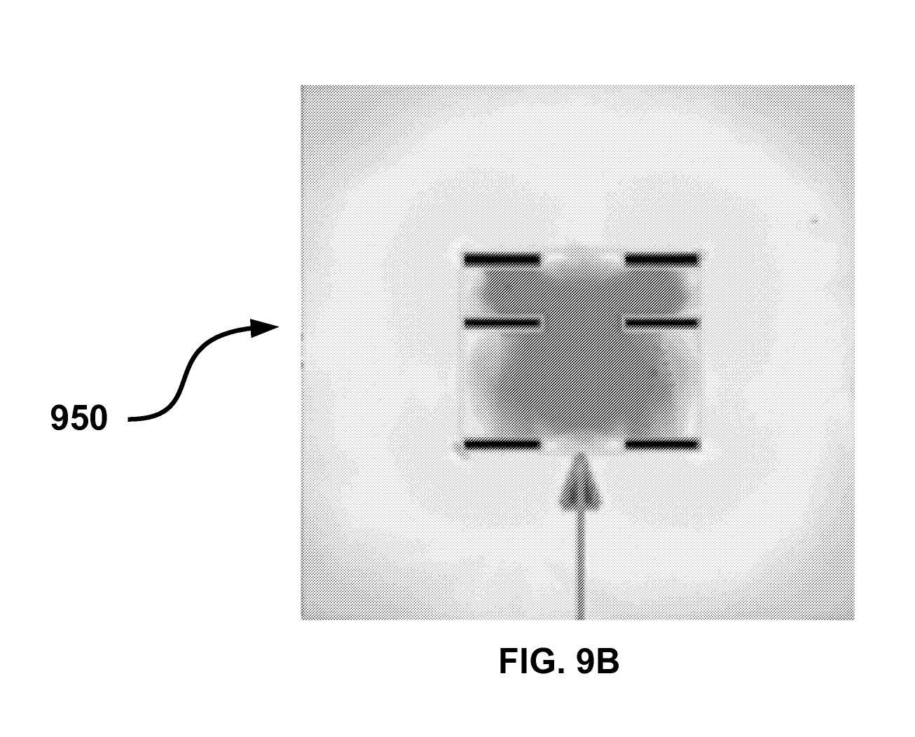

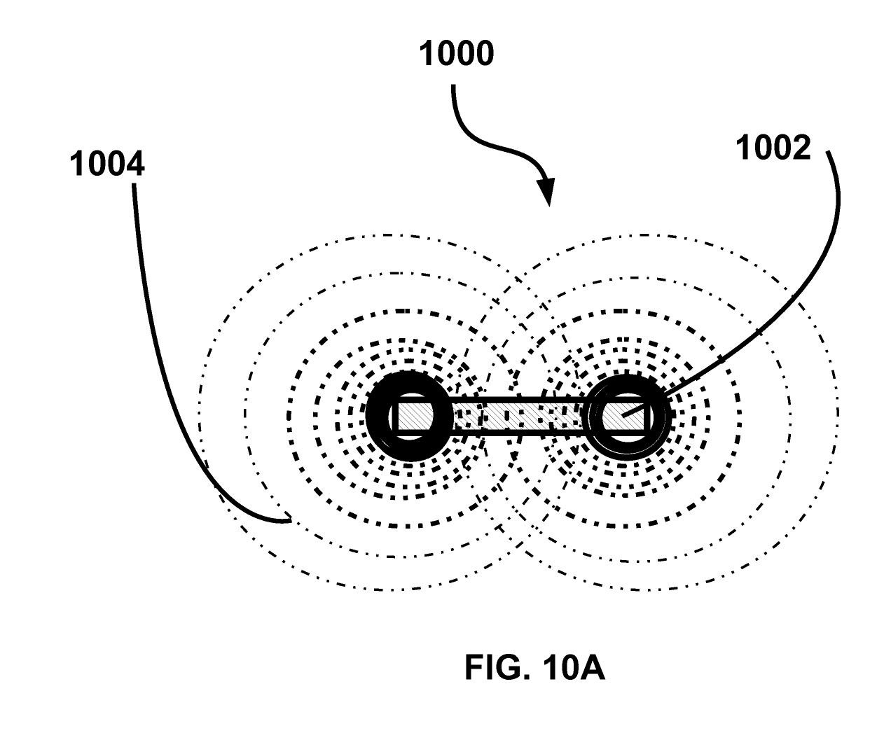

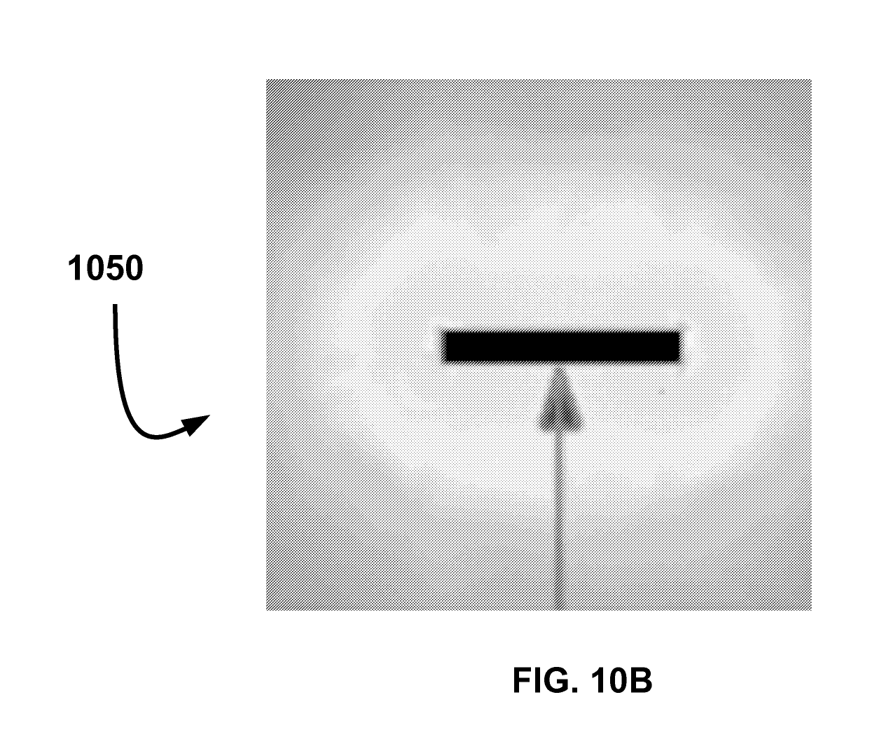

The low inductance in parallel-trace PSCs is due to the mutual magnetic coupling shown in FIG. 9a and FIG. 9b. FIG. 9a is a drawing of FIG. 9b. FIG. 9a depicts a parallel-trace PSC 900, which has parallel-traces 902. 904 in FIG. 9a illustrate the magnetic flux density whose direction is parallel to the electrical current direction. In comparison, FIG. 10a and FIG. 10b depict a single-trace PSC 1000, which include single-trace 1002. FIG. 10a is the drawing of FIG. 10b. 1004 depicts the magnetic flux density whose direction is parallel to the electrical current direction. The magnetic flux density 904 of the parallel-trace 902 seems to be greater than the magnetic flux density 1004 of the single-trace 1002.

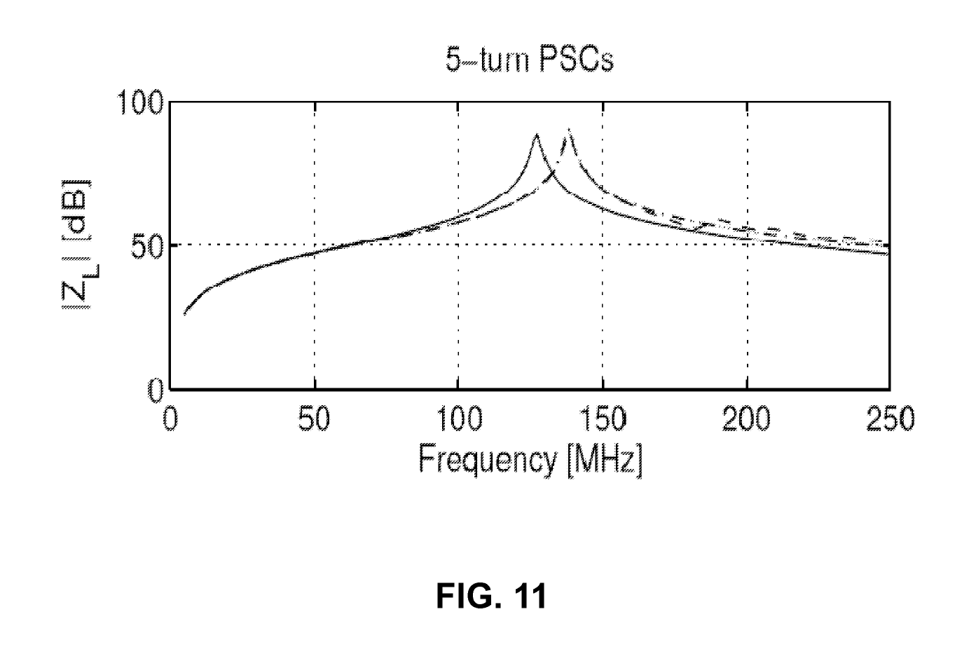

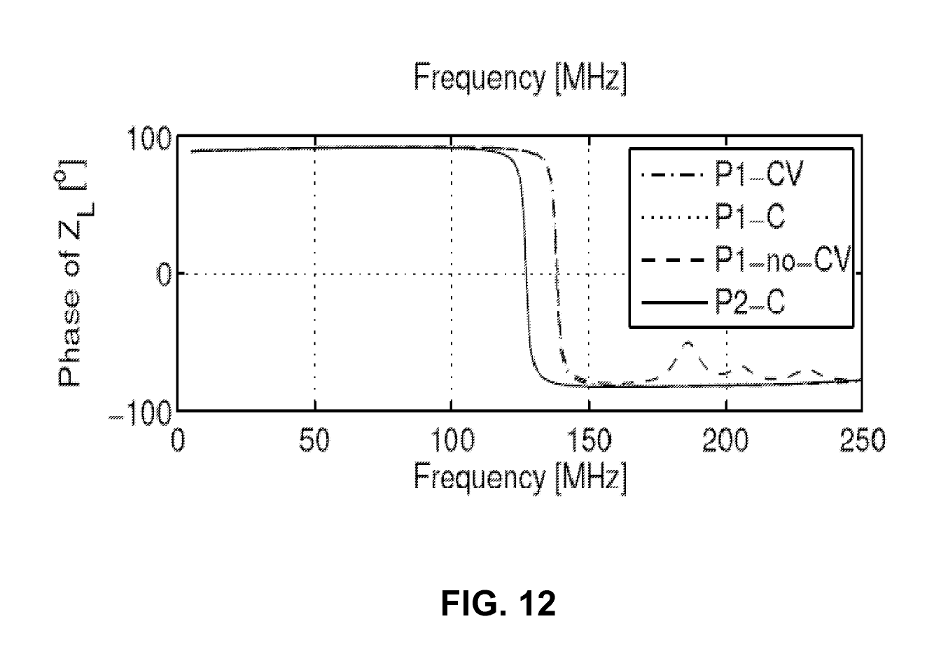

FIG. 11 illustrates the magnitude (in dB) versus frequency for the 5-turn PSC. FIG. 12 illustrates the phase (in degree) of effective impedance versus frequency for the 5-turn PSC.

In FIG. 12, P1-CV represents the embodiment in FIG. 7, P1-no-CV represents embodiment in FIG. 6. P1-C represents embodiment in FIG. 8 with the top-layer (top horizontal plane) exposed to different dielectric (open-air) and P2-C represents the embodiment in FIG. 8 with all the layers embedded in the substrate. The graphs of FIG. 11 and FIG. 12 indicate that PSCs without vertical vias or stubs in the corner have some high-order resonances above the self-oscillation frequency. Further, there is no material difference in impedance among the parallel-trace PSCs with different designs when operating at frequencies that are lower than their self-oscillation frequencies.

The overall experimental results indicate that the parasitic resistance of a parallel-trace PSC design is lower than the parasitic resistance of a corresponding single-trace PSC design. The design objectives of achieving a better Q factor compared to a single-trace PSC is also achieved. Further, the inductance of the parallel-trace PSC is smaller than that of the single-trace PSC. The metal stubs at the corners and/or the vertical vias between different layers of the metals make a small material difference and may not be needed for low-frequency operation.

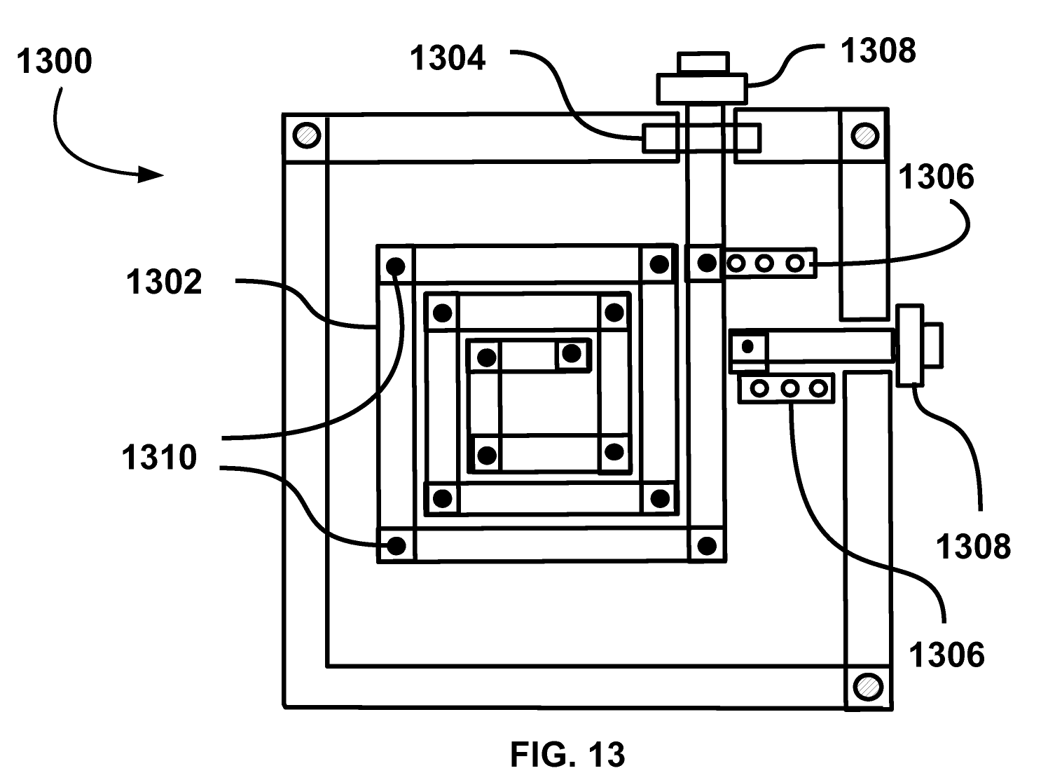

FIG. 13 depicts top-view of a 3-turn parallel-trace PSC with 3 horizontal planes and with two parallel metal traces placed side-by-side in each horizontal plane 1302. 1308 represents the connector at each end of the PSC wherein the metal-traces of different horizontal planes are connected together. 1304 depicts the ground and 1306 represents a slot for a capacitor component. 1302 depicts the 3-turn PSC and 1310 depicts the cylindrical vias with stubs at the turning corners of the PSC.

What is claimed is:

1. An inductive coil for a medical implant, comprising a plurality of conductors arranged in parallel electrical connection to one another and arranged in connection with a substrate; including a first set of two of said conductors are arranged side-by-side adjacent one another and joined at turning portions by a conductive interconnection configured to minimize differences in length, and at least one additional set of two additional conductors arranged side-by-side adjacent one another and joined at turning portions by a conductive interconnection configured to minimize differences in length, said additional set being spaced in a different plane from said first set to form a common inductive coil in which an induced current may take multiple parallel paths available through said conductors so as to provide a relatively high Q factor, with reduced parasitic resistance and low inductance for use in bio-medical implants.

2. An inductive coil for a medical implant as set forth in claim 1, including at least three sets of said conductors arranged in differing planes with each set of conductors having the same number of conductors.

3. An inductive coil for a medical implant as set forth in claim 2, wherein there are two conductors for each set.

4. An inductive coil for a medical implant as set forth in claim 3, wherein each conductor is similar in width and thickness.

5. An inductive coil for a medical implant as set forth in claim 2, wherein each conductor is similar in width and thickness.

6. An inductive coil for a medical implant as set forth in claim 1, having another set of said conductors arranged on the surface of said substrate, and the remaining sets of said conductors are embedded within said substrate.

7. An inductive coil for a medical implant as set forth in claim 6, wherein each conductor is similar in width and thickness.

8. An inductive coil for a medical implant as set forth in claim 2, said first set of said conductors are embedded in said substrate in a dielectric material different than said additional set of conductors embedded within said substrate.

9. An inductive coil for a medical implant as set forth in claim 2, the first set of said conductors is arranged on the surface of said substrate, and the remaining sets of said conductors are embedded within said substrate.

10. An inductive coil for a medical implant as set forth in claim 9, wherein each conductor is similar in width and thickness.

11. An inductive coil for a medical implant as set forth in claim 1, each of said first set of said conductors and additional set of conductors is embedded within said substrate.

12. An inductive coil for a medical implant as set forth in claim 11, wherein each conductor is similar in width and thickness.

13. An inductive coil for a medical implant as set forth in claim 11, said first set of said conductors are embedded in said substrate in a dielectric material different than said additional set of conductors embedded within said substrate.

14. An inductive coil for a medical implant as set forth in claim 2, each of said first set of said conductors and additional set of conductors is embedded within said substrate.

15. An inductive coil for a medical implant as set forth in claim 14, wherein each conductor is similar in width and thickness.

16. An inductive coil for a medical implant as set forth in claim 14, said first set of said conductors are embedded in said substrate in a dielectric material different than said additional set of conductors embedded within said substrate.

17. An inductive coil for a medical implant as set forth in claim 16, wherein each conductor is similar in width and thickness.

18. An inductive coil for a medical implant as set forth in claim 14, each of said sets of said conductors are embedded in said substrate in a common dielectric material.

19. An inductive coil for a medical implant as set forth in claim 4, the first set of said conductors is arranged on the surface of said substrate, and the remaining sets of said conductors are embedded within said substrate and the sum of the thickness of said conductors is approximately 115 μm.

20. An inductive coil for a medical implant as set forth in claim 4, each of said first set of said conductors and additional set of conductors is embedded within said substrate and the sum of the thickness of said conductors is approximately 108 μm.
